(19) United States
(12) Patent Application Publication
(10) Pub. No.: US 2019/0078552 A1
(43) Pub. Date: Mar. 14, 2019

(54) Wind Turbine System

(71) Applicant: The Corrado Family Limited Partnership, LLC, Perkasie, PA (US)

(72) Inventor: Michael L. Corrado, Perkasie, PA (US)

(73) Assignee: The Corrado Family Limited Partnership, LLC, Perkasie, PA (US)

(21) Appl. No.: 16/129,011

(22) Filed: Sep. 12, 2018

Related U.S. Application Data
(60) Provisional application No. 62/557,257, filed on Sep. 12, 2017.

(51) Int. Cl. F03D 3/00; F03D 9/25; F03D 3/06; H02K 7/08; H02K 7/116; H02K 7/18

(52) U.S. Cl. CPC F03D 3/005; F03D 9/25; F03D 3/068; H02K 7/08; H02K 7/116; F05B 2240/30; F05B 2220/706; F05B 2240/211; F05B 2240/912; F05B 2240/50; H02K 7/183

(57) ABSTRACT

A wind turbine includes a vertical column, a rotor supported within the vertical column and extending out of the vertical column, and one or more blades coupled to the rotor and extending outward therefrom. A plurality of segmented, vertically aligned magnetic fields are provided within the vertical column and the rotor extends therethrough. Rotating the rotor within the plurality of segmented, vertically aligned magnetic fields generates electricity.

### BACKGROUND

Most wind energy is captured using wind turbines having one or more blades that are forced into rotational movement by the impingement of naturally occurring wind on the blades. Rotating the blades causes an interconnected drive shaft (or rotor) to rotate within a magnetic field produced within a generator, which generates electric energy that can be used or stored for later use. The amount of kinetic energy that can be harvested from the wind for the production of electricity is a function of wind velocity, the surface area of the blades, and the efficiency of the blade system.

Today, most wind energy is harvested using horizontal-axis wind turbines (HAWT) that include vertically mounted blades that rotate in a vertical plane. There are, however, a few fundamental obstacles in efficiently harvesting wind energy from HAWTs. First, the blade (propeller) design in HAWTs has a natural tendency to “fly” in a direct line just as a plane would fly. Consequently, most HAWTs can safely operate only up to a maximum wind speed (e.g., 50 mph), beyond which the turbine blades must be “furled” or “battened down” or otherwise risk mechanical failure (e.g., detachment). Ironically, these high wind speeds provide the greatest kinetic energy. Second, the blades in a HAWT must face into the wind to operate properly. If the unit does not face the wind, the electrical harvest will drop enormously and possibly to zero. Lastly, while not an issue of power generation, propeller designs in HAWTs have a history of inadvertently killing migratory birds.

For these and other reasons, vertical-axis wind turbines (VAWT) have been developed. VAWTs have a main drive shaft (or rotor) oriented vertically and one or more blades are operatively coupled to the drive shaft to rotate in a horizontal plane. Unlike HAWTs, the blades of a VAWT do not need to be pointed into the wind to be effective. Moreover, blade structures rotating in a horizontal plane are generally more stable than blades rotating in a vertical plane, since horizontally spinning blades can achieve better balance on top of a vertical support. However, when averaged over time, VAWTs generally produce less energy than HAWTs. Accordingly, improvements to the design and operation of VAWTs are desirable to more efficiently harvest wind energy.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of a prior art horizontal-axis wind turbine.

FIG. 2 is a schematic diagram of an example vertical-axis wind turbine, according to one or more embodiments of the present disclosure.

FIG. 3 is a cross-sectional top view of the vertical column of FIG. 2 taken along the lines indicated in FIG. 2.

FIG. 4 is a perspective, schematic view of another example turbine that incorporates one or more principles of the present disclosure.

FIG. 5 is a schematic side view of another example turbine that incorporates one or more principles of the present disclosure.

FIG. 6 is a top view of the turbine of FIG. 5.

FIG. 7 is a fragmented, schematic side view of a portion of the turbine of FIG. 5.

FIG. 8 is a schematic side view of another example turbine that may incorporate one or more principles of the present disclosure.

FIG. 9 is a schematic side view of another example turbine that may incorporate one or more principles of the present disclosure.

FIG. 10 is a schematic side view of another example turbine that may incorporate one or more principles of the present disclosure.

### DETAILED DESCRIPTION

The present disclosure is generally related to wind turbines and, more particularly, to vertical-axis wind turbines that enhance power generation by increasing the length of the metal able to interact with generator magnetic fields.

The embodiments disclosed herein describe vertical-axis wind turbines configured to capture kinetic wind energy and convert the wind energy into electrical energy. One wind turbine includes a vertical column, a rotor supported within the vertical column and extending out of the vertical column, and one or more blades coupled to the rotor and extending outward therefrom. In at least one embodiment, the blades may extend horizontally outward from the vertical column. A plurality of segmented, vertically aligned magnetic fields may be provided within the vertical column and the rotor may extend vertically therethrough. Rotating the rotor within the plurality of segmented, vertically aligned magnetic fields may convert kinetic wind energy into electrical energy. The rotor may pass through one or more support members arranged within the vertical column, and bearings mounted in the support members may help radially and axially support the rotor.

The vertical-axis wind turbines described herein may differ from conventional horizontal-axis wind turbines by including blades that reside in corresponding horizontal planes relative to the vertical column. The plurality of segmented, vertically aligned magnetic fields increases the available magnetic field and thus enables a large increase in harvesting of electrons producing electricity not feasible in current designs.

Also disclosed are vertical-axis wind turbines that incorporate blades that include a tapering arm that is largest at the point where it couples to a vertical support and smallest at the distal tip of the arm and remote from the vertical support. One or more flaps may be coupled to the tapering arm and used to capture wind energy. Turbulence on the blades can be mitigated by using flaps of a graduated size along the length of the arm, such that at any point along the arm, the arm plus the surface area of the flaps presented to the wind is the same. Stated another way, as a side elevation of the arm decreases from the vertical support toward the distal tip of the arm, the side elevation of the flap(s) increases to compensate for the surface area reduced by the arm side elevation presented to the wind.

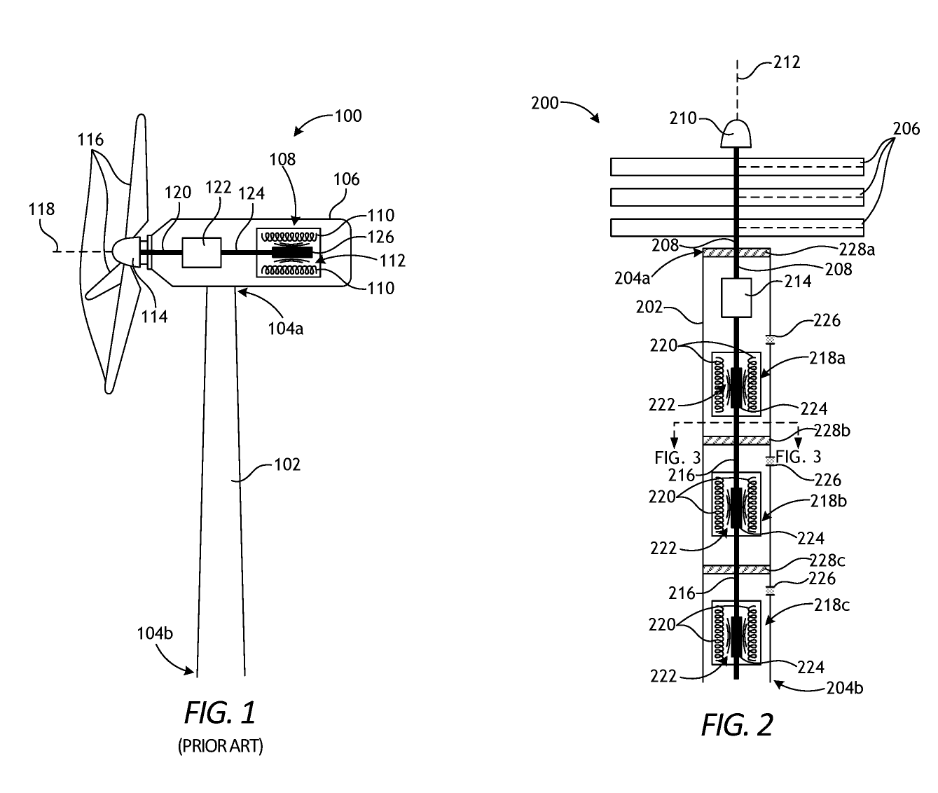

FIG. 1 is a schematic diagram of a prior art horizontal-axis wind turbine 100. As illustrated, the turbine 100 includes a support tower 102 oriented vertically and having a top 104a and a bottom 104b. The support tower 102 is supported for use at the bottom 104b, and a housing or “nacelle” 106 is mounted at the top 104a of the support tower 102. The nacelle 106 houses a generator 108, which can be an off-the-shelf type of generator, such as an induction type generator commonly used for wind turbines. The generator 108 includes one or more coils 110 capable of producing a magnetic field 112 within the generator 108.

A cap 114 is rotatably mounted to the nacelle 106 and one or more vertically oriented blades 116 (three shown) are fixed to the cap 114 and extend radially outward therefrom in a vertical plane. The blades 116 capture wind (i.e., wind energy or the kinetic energy of the wind), which causes the blades 116 and the cap 114 to rotate about a horizontal axis 118. A rotor 120 extends from the cap 114 and correspondingly rotates as the blades 116 and the cap 114 rotate. The rotor 120 is received within a gearbox 122 housed within the nacelle 106, and the gearbox 122 converts rotation of the rotor 120 caused by the slow rotation of the blades 116 into a higher rotational velocity assumed by a distal portion 124 of the rotor 120 that extends from the gearbox 122.

The rotor 120 extends generally horizontal within the nacelle 106 and the distal portion 124 of the rotor 120 extends into the magnetic field 112 produced within the generator 108. In some cases, the distal portion 124 of the rotor 120 (or the entire rotor 120) may be made of a magnetic material and rotating the distal portion 124 within the magnetic field 112 generates electricity. In other cases, a magnetic material 126 may be arranged on the distal portion 124 of the rotor 120 and rotating the magnetic material 126 within the magnetic field generates electricity. The wind speed and the rotational velocity of the distal portion 124 of the rotor 120 govern the amount of electricity generated.

FIG. 2 is a schematic diagram of an example vertical-axis wind turbine 200, according to one or more embodiments of the present disclosure. As illustrated, the turbine 200 may include a support tower, referred to herein as a vertical column 202. The vertical column 202 is oriented vertically and has a first end or “top” 204a and a second end or “bottom” 204b. The vertical column 202 may be supported for use at the bottom 204b, and one or more horizontally oriented blades 206 may be arranged at or near the top 204a.

Each blade 206 may be coupled to a vertically oriented rotor 208 and may extend radially outward from the rotor 208 in corresponding horizontal planes. In the illustrated embodiment, each blade 206 is coupled to the rotor 208 opposite an adjacent blade 206 also coupled to the rotor 208 and arranged in the same horizontal plane. While three sets or pairs of blades 206 are depicted in FIG. 2 and residing in three distinct horizontal planes, more or less than three sets or pairs of blades 206 may be employed. Moreover, in other embodiments, one or more single or solitary blades 206 may be arranged in individual horizontal planes, without departing from the scope of the disclosure.

In some embodiments, a cap 210 may be fixed to one end of the rotor 208, but may alternatively be omitted in other designs. As the blades 206 capture wind energy, the blades 206 and the rotor 208 are rotated about a vertical axis 212. In some embodiments, the rotor 208 may be received within a gearbox 214 housed within the vertical column 202. In other embodiments, the gearbox 214 may be arranged outside of the vertical column 202 or entirely omitted from the turbine 200, without departing from the scope of the disclosure. The gearbox 214 may be configured to convert the rotational movement of the rotor 208 into a higher rotational velocity assumed by a distal portion 216 of the rotor 208 extending from the gearbox 214.

A plurality of generators may be arranged within the vertical column 202, shown as a first generator 218a, a second generator 218b, and a third generator 218c. As illustrated, the generators 218a-c may be segmented (separated), and vertically aligned within the vertical column 202. Each generator 218a-c includes one or more coils 220 capable of producing a corresponding magnetic field 222 within the associated generator 218a-c. Accordingly, the plurality of generators 218a-c may be characterized as providing a plurality of segmented (separate), vertically aligned magnetic fields 222. While three generators 218a-c are depicted, more or less than three may be employed, without departing from the scope of the disclosure. In at least one embodiment, for example, the three generators 218a-c may be combined or otherwise comprise a single generator that includes the vertically aligned coils 220. In such embodiments, the single generator may similarly provide a plurality of segmented, vertically aligned magnetic fields 222.

The distal portion 216 of the rotor 208 extends vertically downward within the vertical column 202 and into the vertically aligned magnetic fields 222. In some cases, the distal portion 216 (or alternatively the entire rotor 208) may be made of a magnetic material and rotating the distal portion 216 within the magnetic fields 222 generates electricity. In other cases, a magnetic material 224 (e.g., a sleeve or the like) may be arranged on the distal portion 216 of the rotor 208 at predetermined intervals to align with the magnetic fields 222, and rotating the sections of the magnetic material 224 within the magnetic fields 222 generates electricity. The wind speed and the rotational velocity of the distal portion 216 of the rotor 208 govern the amount of electricity generated.

In some embodiments, one or more apertures 226 may be defined in the sidewall of the vertical column 202. The apertures 226 may help provide ventilation for the interior of the vertical column 202 and thereby maintain the temperature of the generators 218a-c at lower levels. In at least one embodiment, the apertures may be occluded with a mesh-like structure or vent that allows airflow therethrough but prevents the ingress of insects and birds.

As illustrated, the rotor 208 may pass through one or more support members, shown as a first support member 228a, a second support member 228b, and a third support member 228c. The support members 228a-c may comprise any structure or device that helps maintain the rotor 208 centrally located within the vertical column 202 and prevent the rotor 208 from distorting (twisting) as it rotates along the length of the vertical column 202. In the illustrated embodiment, the support members 228a-c are depicted as plates having a planar construction. In other embodiments, however, one or more of the support members 228a-c may comprise a structural block or a segmented annular ring of material. Moreover, while three support members 228a-c are depicted, more or less than three may be included in the turbine 200, without departing from the scope of the disclosure.

The first support member 228a may be arranged at or near the top 204a of the vertical column 202, and the rotor 208 may enter the vertical column 202 through the first support member 228a. The second and third support members 228b,c may be axially offset from each other within the vertical column 202. In the illustrated embodiment, for example, the second support member 228b is arranged axially between the first and second generators 218a,b, and the third support member 228c is arranged axially between the second and third generators 218b,c. The support members 228a-c may form individual vertically aligned chambers defined within the vertical column 202 and axially offset from each other. Accordingly, the coils 220 may produce corresponding magnetic fields 222 within each chamber, and the rotor 208 may be characterized as extending through a plurality of segmented (separated), vertically aligned chambers that each provide a magnetic field 222.

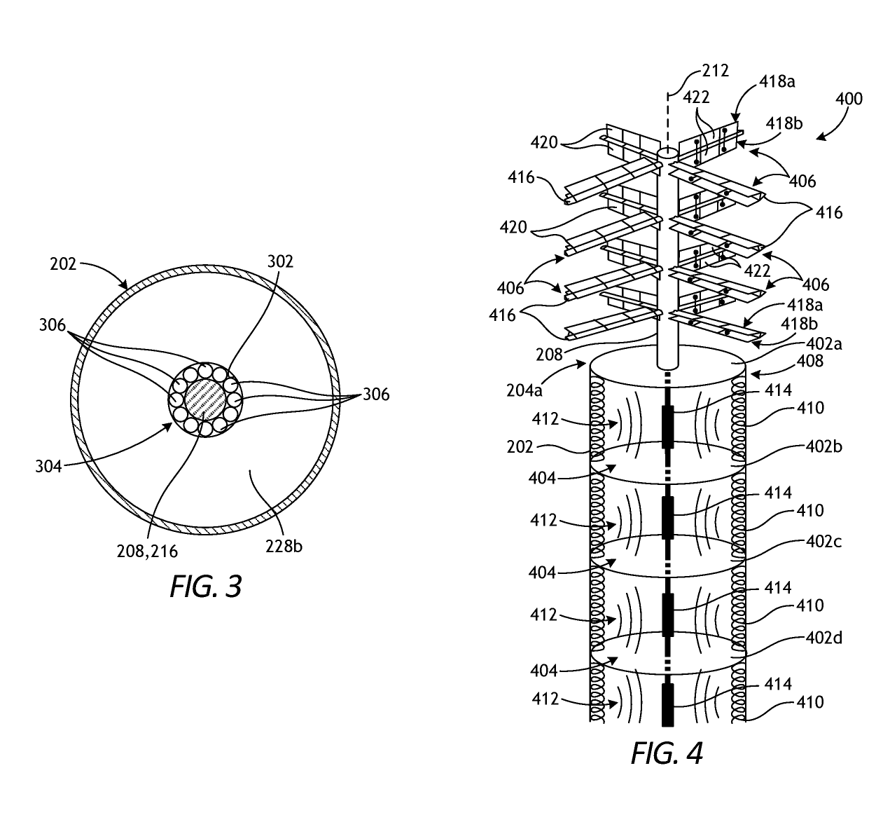

FIG. 3 is a cross-sectional top view of the vertical column 202 taken along the lines indicated in FIG. 2. More specifically, FIG. 3 depicts the rotor 208 (i.e., the distal portion 216) in cross-section extending through a top view of the second support member 228b. In the illustrated embodiment, the vertical column 202 has a circular cross-section, but could alternatively assume other cross-sectional shapes including, but not limited to, polygonal (e.g., triangular, rectangular, pentagonal, etc.), oval, ovoid, or any combination thereof.

The second support member 228b may be substantially similar in form and function as the first and third support members 228a,c of FIG. 2. Accordingly, the following description of the second support member 228b may be equally applicable to the first and third support members 228a,c. As illustrated, the second support member 228b provides or otherwise defines a central aperture 302 and the rotor 208 is axially extendable through the central aperture 302. In some embodiments, a bearing 304 may be arranged in the central aperture 302 and interpose the rotor 208 and the second support member 228b. The bearing 304 may be configured to provide radial and axial support to the rotor 208 within the central aperture 302, and thus help prevent the rotor 208 from buckling from the potential thermal energy generated from rotation. Moreover, the bearing 304 may also be configured to help reduce friction as the rotor 208 rotates relative to the vertical column 202.

The bearing 304 may comprise any type of machine element that constrains relative motion of the rotor 208 and reduces friction. Suitable bearing types that may be used as the bearing 304 include, but are not limited to, a plain bearing (e.g., bushing, journal bearing, sleeve bearing, rifle bearing, composite bearing, etc.), a rolling-element bearing (e.g., a ball bearing, a roller bearing, etc.), a jewel bearing, a fluid bearing, a magnetic bearing, a flexure bearing, or any combination thereof. In the illustrated embodiment, the bearing 304 comprises a rolling-element bearing having a plurality of ball bearings 306. As the rotor 208 rotates relative to the second support member 228b, the ball bearings 306 simultaneously roll to reduce rotational friction and support radial and axial loads.

FIG. 4 is a perspective, schematic view of another example turbine 400 that may incorporate one or more principles of the present disclosure. The turbine 400 may be similar in some respects to the turbine 200 of FIG. 2 and therefore will be best understood with reference thereto, where like numerals correspond to like components not described again in detail. As illustrated, the turbine 400 includes the vertical column 202 and the rotor 208 extends vertically within the vertical column 202.

The rotor 208 may pass through one or more support members, shown as a first support member 402a, a second support member 402b, a third support member 402c, and a fourth support member 402d. The support members 402a-d may be similar to the support members 228a-c of FIG. 2 and thus may help maintain the rotor 208 centrally located within the vertical column 202 and prevent the rotor 208 from distorting (twisting) as it rotates along the length of the vertical column 202. Moreover, the support members 402a-d may comprise plates, structural blocks, segmented annular rings of material, or any combination thereof. While four support members 402a-d are depicted, more or less than four may be included in the turbine 400, without departing from the scope of the disclosure.

As illustrated, the first support member 402a may be arranged at or near the top 204a of the vertical column 202, and the rotor 208 may enter the vertical column 202 through the first support member 402a. The second, third, and fourth support members 402b-d may be axially offset from each other within the vertical column 202 and thereby help form individual chambers 404 defined within the vertical column 202. Each chamber 404 may be segmented (separated) by the support plates 402a-d and vertically aligned within the vertical column 202.

One or more horizontally oriented blades 406 may be coupled to the rotor 208 and extend radially outward from the rotor 208 in corresponding horizontal planes. In the illustrated embodiment, sets of four blades 406 are coupled to the rotor 208 in four corresponding horizontal planes. While four sets of blades 406 are depicted in FIG. 4 and residing in four distinct horizontal planes, more or less than four sets of blades 406 may be employed, without departing from the scope of the disclosure. As the blades 406 capture wind energy, the blades 406 and the rotor 208 are rotated about the vertical axis 212.

The vertical column 202 may house a generator 408 that includes a plurality of coils 410 operable to produce a corresponding plurality of magnetic fields 412. As illustrated, one or more coils 410 may be arranged within and produce a corresponding magnetic field 412 within each chamber 404. Accordingly, the rotor 208 may be characterized as extending through a plurality of segmented, vertically aligned chambers 404, where each chamber 404 provides a separate (discrete) magnetic field 412.

In some cases, the rotor 208 may be made of a magnetic material and rotating the rotor 208 within the magnetic fields 412 generates electricity. In other cases, a magnetic material 414 (e.g., a sleeve or the like) may be arranged on the rotor 208 at predetermined intervals to align with the chambers 404, and rotating the sections of the magnetic material 414 within the magnetic fields 412 generates electricity. The wind speed and the rotational velocity of the rotor 208 govern the amount of electricity generated.

In the illustrated embodiment, a gearbox (e.g., the gearbox 214 of FIG. 2) is omitted from the turbine 400, but could alternatively be used to help enhance the rotational velocity of the rotor 208. A prototype of the turbine 400 was built and tested at the University of Pittsburgh School of Engineering. It was discovered that at low wind velocities (e.g., 10-12 mph) the turbine 400 was more efficient when a gearbox was used to help spin the rotor 208 faster. This unexpected finding occurred only at low wind velocities, while at higher wind velocities the turbine 400 with or without the gearbox achieved essentially the same efficiency. From this discovery, it was concluded that surface area for surface area, with the equivalent wind velocity, the turbine 400 may yield more electricity in low wind speeds.

A variable identified with greater potential to generate electricity is the amount of metal (e.g., the magnetic material 414) spinning within the magnetic fields 412. In conventional horizontal-axis wind turbines (e.g., the horizontal-axis wind turbine 100 of FIG. 1), the axial length of the metal exposed to a magnetic field is restricted by the size of the housing (e.g., the nacelle 106 of FIG. 1) that can be expected to stably sit atop the support tower (e.g., the support tower 102 of FIG. 1). The turbines 200 and 400 of FIGS. 2 and 4, respectively, may prove advantageous in increasing the length of the metal able to interact with the magnetic fields 222 (FIG. 2) and 412 (FIG. 4) along a large portion of the axial length of the vertical column 202, thus yielding more electricity from the generators 218a-c (FIG. 2) and 408 (FIG. 4).

Moreover, conventional vertical-axis turbines typically only include one magnetic field, whereas the embodiments disclosed herein include a plurality of segmented (e.g., separate, discrete), vertically aligned magnetic fields 222, 412 that significantly increase the length of the metal able to interact with the magnetic fields 222, 412. Consequently, one vertical-axis turbine incorporating the principles of the present disclosure may be capable of replacing several conventional vertical-axis turbines and generate an equivalent amount of electricity (or more). As will be appreciated, this may prove advantageous in reducing the required footprint for a wind farm.

Still referring to FIG. 4, the blades 406 may comprise a design similar to the designs described in co-owned U.S. Pat. No. 8,282,350, issued on Oct. 9, 2012, the contents of which are hereby incorporated by reference in their entirety. As illustrated, each blade 406 comprises a blade assembly that includes a blade arm 416 attached to the rotor 208 and having a first flap 418a and a second flap 418b pivotably coupled to the corresponding blade arm 416. In some embodiments, however, only one of the flaps 418a,b may be included in the blade assembly and pivotably coupled to the corresponding blade arm 416, without departing from the scope of the disclosure.

The first and second flaps 418a,b are each pivotable on the corresponding blade arm 416 between a substantially horizontal position and a substantially vertical position. When the flaps 418a,b are in the vertical position they are considered to be “open” and capable of capturing wind energy, and when the flaps 418a,b are in the horizontal position they are considered to be “closed” and more aerodynamically situated to cut through the wind. Each flap 418a,b has a leading face 420 and a trailing face 422. When capturing wind, the flaps 418a,b pivot from the closed position to the open position and the trailing faces 422 become exposed to receive the wind and thereby transfer the kinetic energy of the wind to the corresponding blade arm 416, which rotates the blade 406 and the rotor 208. In contrast, when the leading faces 420 are rotated to face the wind, the flaps 418a,b are then urged to collapse back to the closed position. As will be appreciated, transitioning to the closed position places the blades 406 in a more aerodynamic configuration that reduces drag on the blades 406 and thereby increases efficiency.

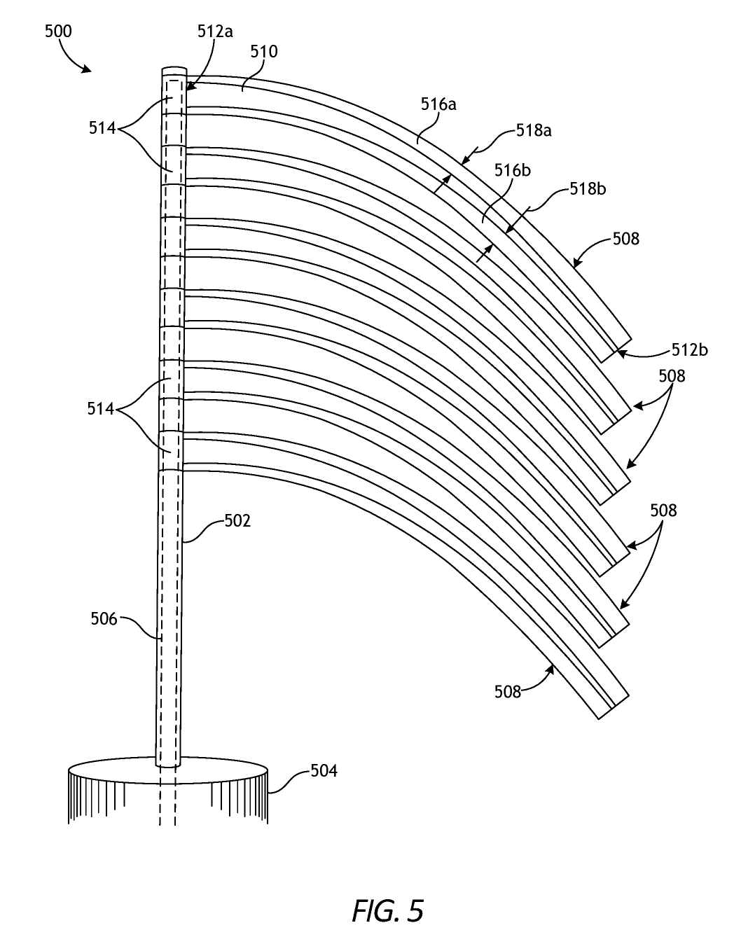

FIG. 5 is a schematic side view of another example turbine 500 that may incorporate one or more principles of the present disclosure. The turbine 500 may be similar in some respects to the turbines 200, 400 of FIGS. 2 and 4, respectively, and therefore will be best understood with reference thereto. As illustrated, the turbine 500 includes a support pole 502 coupled to a vertical column 504. In at least one embodiment, at least a portion of the vertical column 504 may comprise a cement encasement. A rotor 506 (shown in dashed lines) may be rotatably positioned within the support pole 502 and extend vertically into the vertical column 504. While not shown, the turbine 500 may further include one or more generators housed within the vertical column 504 and otherwise operatively coupled to the rotor 506. Rotation of the rotor 506 in the presence of a magnetic field generated by such generator(s) may create an electrical voltage for transmitting electrical power for end use.

The turbine 500 may further include one or more blades 508 rotatably coupled to the support pole 502. Each blade 508 may include an arm 510 having a proximal end 512a and a distal end 512b opposite the proximal end 512a. The proximal end 512a of each arm 510 may be secured to a rotatable coupling 514, and each rotatable coupling 514 may be mounted (attached) to the rotor 506 and rotatable relative to the support pole 502.

In the illustrated embodiment, each arm 510 forms an arc that extends downwardly toward the distal end 512b. In some embodiments, the arc may result from of the overall weight of each blade 508. In other embodiments, however, the arcuate shape may be intentionally formed into the blades 508 to allow the blades 508 to spin faster. More specifically, having the blades 508 extend downwardly decreases the rotational inertia of the corresponding blade 508, which can increase the rotational rate of the blades 508, thus taking advantage of the physical principle of conservation of angular momentum. With an increase in rotational rate, the rotor 506 may be able to spin faster, which promotes a greater harvest of wind energy.

Each blade 508 may further include a first flap 516a extending outward a first distance 518a from an outer surface of the arm 510. In some embodiments, each blade 508 may also include a second flap 516b extending outward a second distance 518b from the outer surface of the arm 510, but on the opposite side of the arm 510. In such embodiments, the first and second flaps 516a,b may extend away from each other in the same plane.

In some embodiments, the first and second flaps 516a,b may be attached to the arm 510 at two locations: 1) at or near the proximal end 512a of the arm 510, and 2) at or near the distal end 512b of the arm 510. It will be appreciated, however, that the first and second flaps 516a,b may be attached to the arm 510 at more or less than two locations, without departing from the scope of the disclosure.

In some embodiments, as illustrated, the arm 510 of each blade 508 may taper in cross-section from the proximal end 512a toward the distal end 512b, thus exhibiting a progressively smaller cross-section as it extends away from the support pole 502. The weight of each blade 508 will be borne primarily at the proximal end 512a where the arm 510 is attached to the corresponding rotatable coupling 514. Consequently, structural fatigue of the arm 510 is most likely to occur at the proximal end 512a. For this reason, it may be advantageous that the proximal end 512a of the arm 510 is most robust at this point (e.g., largest in circumference if circular or other shape largest in cross-sectional dimension).

The distal end 512b of the arm 510 is also an important point on each blade 308 since the greatest moment of torque can be provided to the rotor 506 from that point. The longer the arm 510, the greater the torque assumed by the rotor 506. However, as the length of the arm 510 increases to increase the torque, the weight of the arm 510 correspondingly increases, which places greater structural stress on the arm 510 at the proximal end 512a. Therefore, a balance must be struck between increasing torque and decreasing structural weight bearing. Implementing a tapering arm 510 with a progressively decreasing diameter or cross-section extending from the support pole 502, allows the length of the arm 510 to be increased to enhance the potential torque output of the blade 208. Any structural change that decreases the weight as the arm 510 extends toward the distal end 512b may help the balance between torque and weight.

It should be noted that while FIG. 5 depicts the cross-section of the arm 510 as progressively decreasing in size in a continuous (constant) manner, it is alternatively contemplated herein that the cross-section of the arm 510 may decrease in size in a non-continuous (non-constant) manner. In such embodiments, the cross-section of the arm 510 may be stepped, for example, without departing from the scope of the disclosure.

In some embodiments, the first distance 518a of the first flap 516a may progressively increase as it extends away from the support pole 502 and toward the distal end 512b. Similarly, the second distance 518b of the second flap 516b may progressively increase as it extends away from the support pole 502 and toward the distal end 512b. Accordingly, as the arm 510 progressively tapers to a smaller cross-section toward the distal end 512b, the first and second distances 518a,b may progressively increase toward the distal end 512b. In at least one embodiment, the first and second distances 518a,b and the cross-section of the arm may be inversely proportional at any given point along the arm as extending between the proximal and distal ends 512a,b.

Progressively increasing the first and second distances 518a,b of the flaps 516a,b toward the distal end 512b correspondingly increases the available surface area of the flaps 516a,b to capture kinetic wind energy. In some embodiments, as the arm 510 decreases in size or cross-section, the distances 518a,b of the first and second flaps 516a,b may increase proportionately. In such embodiments, the total surface area of each blade 508, namely, the combined surface area of the arm 510 and the first and second flaps 516a,b, may remain the same along the entire length of the arm 510. In other embodiments, however, the distances 518a,b of the first and second flaps 516a,b may increase disproportionately as compared to the decrease in size of the arm 510 toward the distal end 512b. In such embodiments, the total surface area of the corresponding blade 508 may increase, which may correspondingly increase the potential torque output of the blade 508.

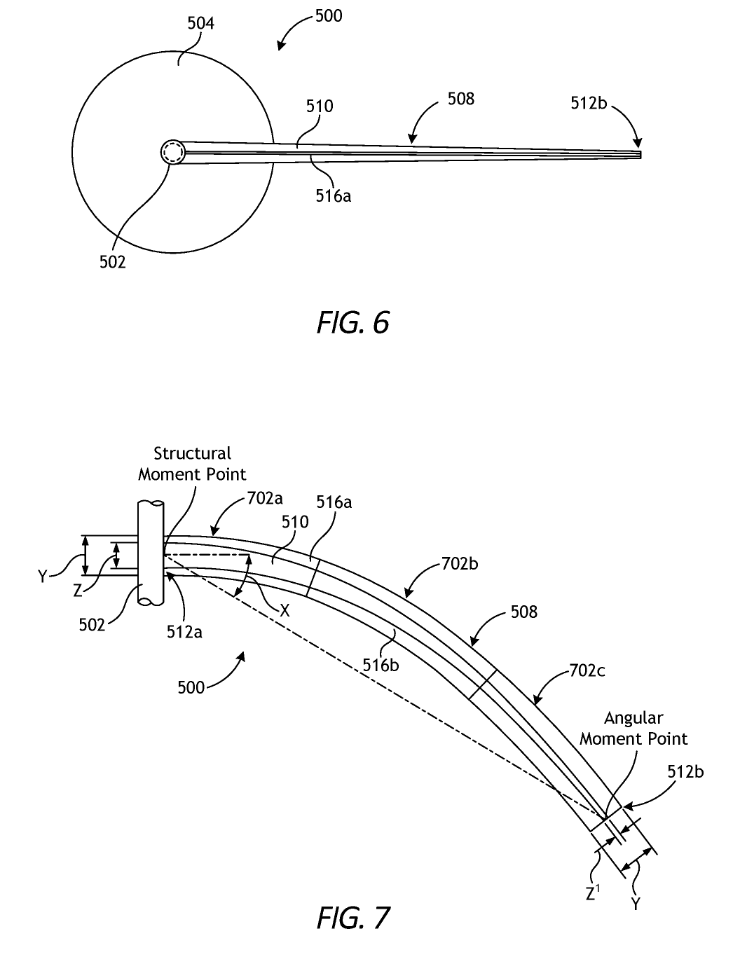

FIG. 6 is a top view of the turbine 500 of FIG. 5. As illustrated, the blade 508 extends radially outward from the support pole 502, which is coupled to the vertical column 504. The blade 508 includes the arm 510 and the first flap 516a is visible extending outward from an outer surface of the arm 510. In the illustrated embodiment, the arm 510 is generally circular in cross-section. In other embodiments, however, the arm 510 may have a polygonal cross-section, without departing from the scope of the disclosure. As is also illustrated, the thickness, size, or volume of the arm 510 progressively decreases (tapers) toward the distal end 512b.

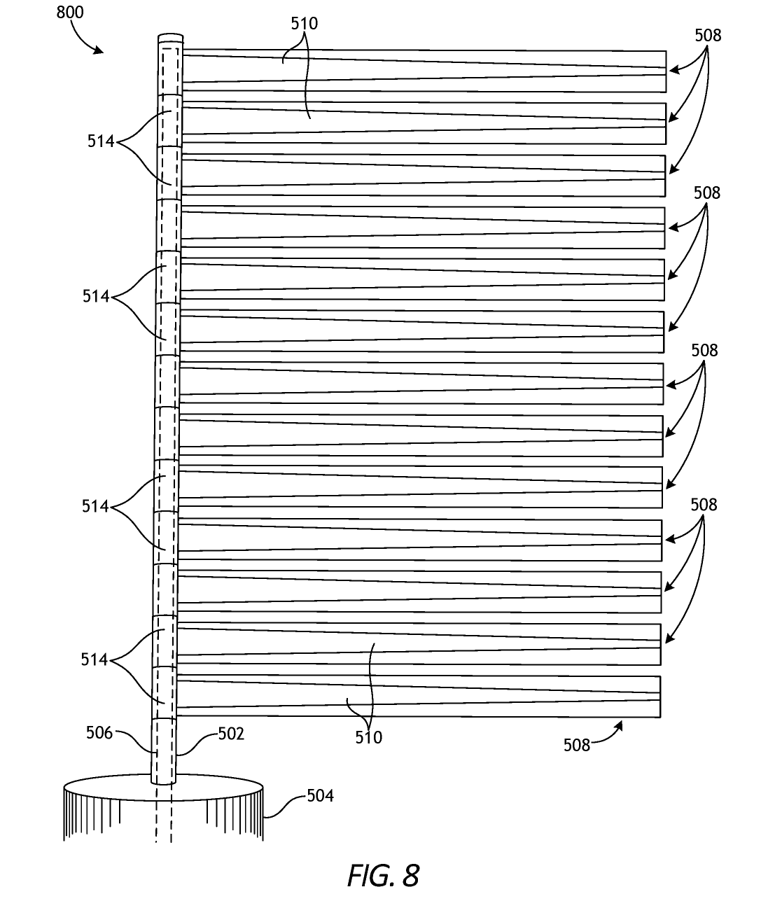

FIG. 7 is a fragmented, schematic side view of a portion of the turbine 500 of FIG. 5. More specifically, FIG. 7 depicts a single blade 508 rotatably coupled to the support pole 502. The arm 510 and the first and second flaps 516a,b cooperatively form an arc extending progressively downward from the proximal end 512a toward the distal end 512b. The arm 510 is depicted as having a thickness Z at or near the proximal end 512b, which progressively tapers toward the distal end 512b where the arm 510 exhibits a reduced thickness Z′. The total surface area Y of the blade 508 includes the combined surface area of the arm 510 and the first and second flaps 516a,b. As illustrated, the total surface area Y remains substantially constant between the proximal and distal ends 512a,b.

In the illustrated embodiment, the blade 508 is segmented into multiple blade segments, shown as a first blade segment 702a, a second blade segment 702b, and a third blade segment 702c. As the blade 508 operates, the first and second flaps 516a,b repeatedly pivot between open and closed positions to capture air (open) and cut through the air (closed). This repeated pivoting movement can cause wear and tear on the blade 508, which decreases operational efficiency. Segmenting the blade 508 into segments 702a-c allows damaged segments 702a-c of the blade 508 to be individually removed and replaced or repaired as needed.

A structural moment point is defined or otherwise provided where the arm 510 is rotatably coupled to the support pole 502. An angular moment point is defined or otherwise provided at the distal end 512b of the blade 508. As illustrated, the structural moment point where the center of the arm 510 is rotatably coupled to the support pole 510 forms an angle X in relation to the angular moment point at the distal end 512b.

FIG. 8 is a schematic side view of another example turbine 800 that may incorporate one or more principles of the present disclosure. The turbine 800 may be similar in some respects to the turbine 500 of FIG. 5 and therefore will be best understood with reference thereto, where like numerals will represent like elements not described again. As illustrated, the turbine 800 includes the support pole 502 coupled to the vertical column 504, and the rotor 506 (shown in dashed lines) may be rotatably positioned within the support pole 502 and extends vertically into the vertical column 504. Moreover, the blades 508 are rotatably coupled to the rotor 506 at corresponding rotatable couplings 514. Unlike the blades 508 of FIG. 5, however, the arm 510 of each blade 508 may extend perpendicular to the support pole 502 such that each blade 508 resides generally in a separate horizontal plane.

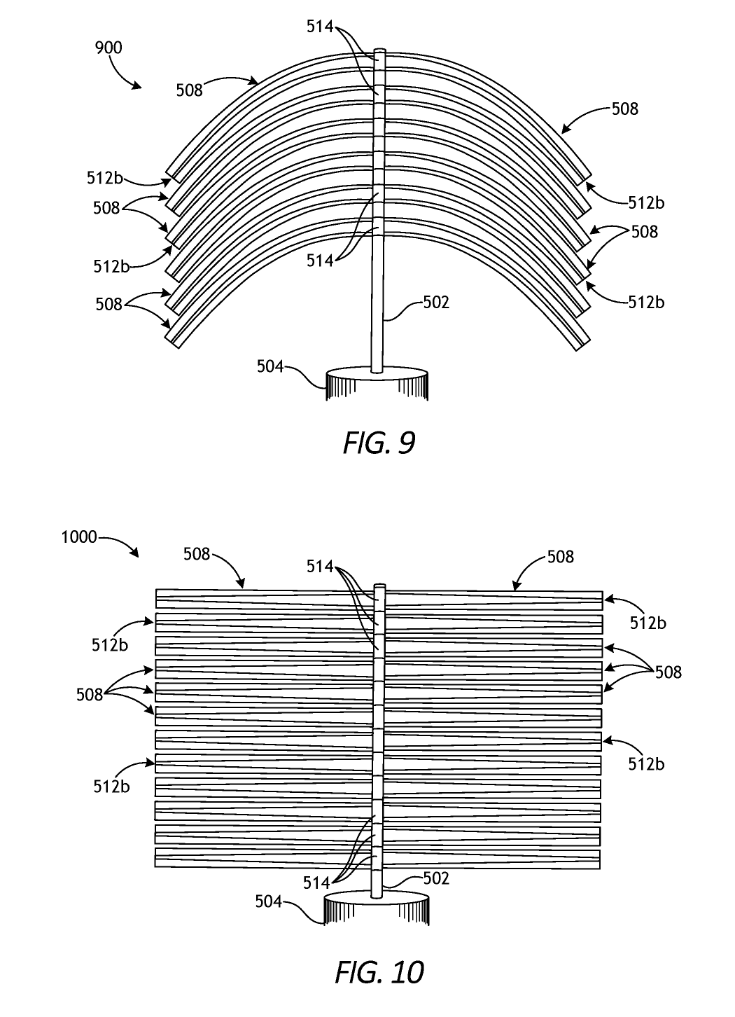

FIG. 9 is a schematic side view of another example turbine 900 that may incorporate one or more principles of the present disclosure. The turbine 900 may be similar in some respects to the turbine 500 of FIG. 5 and therefore will be best understood with reference thereto, where like numerals will represent like elements not described again. As illustrated, the turbine 900 includes the support pole 502 coupled to the vertical column 504, and the blades 508 are coupled to corresponding rotatable couplings 514 on the support pole 502 and arc downwardly toward the distal end 512b.

In the illustrated embodiment, each blade 508 is coupled to a corresponding rotatable coupling 514 opposite an adjacent blade 508 also coupled to the corresponding rotatable coupling 514. Accordingly, opposing blades 508 coupled to the same rotatable coupling 514 will rotate in unison. While six sets or pairs of blades 508 are depicted in FIG. 9, more or less than six sets or pairs of blades 508 may be employed.

FIG. 10 is a schematic side view of another example turbine 1000 that may incorporate one or more principles of the present disclosure. The turbine 1000 may be similar in some respects to the turbine 800 of FIG. 8 and therefore will be best understood with reference thereto, where like numerals will represent like elements not described again. As illustrated, the turbine 1000 includes the support pole 502 coupled to the vertical column 504, and the blades 508 are coupled to corresponding rotatable couplings 514 on the support pole 502 and extend away from the support pole 502 and otherwise toward the distal end 512b in separate horizontal planes.

In the illustrated embodiment, each blade 508 is coupled to a corresponding rotatable coupling 514 opposite an adjacent blade 508 also coupled to the corresponding rotatable coupling 514 and arranged in the same horizontal plane. Accordingly, opposing blades 508 coupled to the same rotatable coupling 514 will rotate in unison. While twelve sets or pairs of blades 508 are depicted in FIG. 10, more or less than twelve sets or pairs of blades 508 may be employed.

Embodiments disclosed herein include:

A. A wind turbine includes vertical column, a rotor supported within the vertical column and extending out of the vertical column, one or more blades coupled to the rotor and extending outward therefrom, and a plurality of segmented, vertically aligned magnetic fields provided within the vertical column and through which the rotor extends, wherein rotating the rotor within the plurality of segmented, vertically aligned magnetic fields generates electricity.

B. A method of generating electricity includes capturing wind energy with one or more blades of a wind turbine, the wind turbine including a vertical column and a rotor supported within the vertical column and extending out of the vertical column, wherein the one or more blades are coupled to the rotor and extend outward therefrom, rotating the one or more blades with the wind energy and thereby rotating the rotor, and generating electricity as the rotor rotates within a plurality of segmented, vertically aligned magnetic fields provided within the vertical column.

Each of embodiments A and B may have one or more of the following additional elements in any combination: Element 1: wherein the one or more blades extend horizontally from the rotor. Element 2: wherein two or more blades of the one or more blades reside in a common horizontal plane. Element 3: further comprising one or more generators arranged within the vertical column, wherein each generator includes one or more coils and the one or more coils produce the plurality of segmented, vertically aligned magnetic fields. Element 4: wherein the one or more generators comprise a plurality of generators that are segmented, and vertically aligned within the vertical column. Element 5: further comprising a magnetic material coupled to the rotor to align with the plurality of segmented, vertically aligned magnetic fields. Element 6: further comprising a gearbox that receives the rotor, wherein a distal end of the rotor extends from the gearbox and through the plurality of segmented, vertically aligned magnetic fields. Element 7: wherein the gearbox is housed within the vertical column. Element 8: further comprising one or more support members coupled to the vertical column, wherein each support member defines a central aperture through which the rotor passes. Element 9: wherein the one or more support members comprise a plurality of support members axially offset from each other within the vertical column, the wind turbine further comprising a plurality of vertically aligned chambers defined within the vertical column by the plurality of support members, wherein the plurality of segmented, vertically aligned magnetic fields are provided within the plurality of vertically aligned chambers. Element 10: further comprising a bearing arranged in the central aperture of at least one of the one or more support members and interposing the rotor and the at least one of the one or more support members. Element 11: wherein the bearing comprises a machine element selected from the group consisting of a plain bearing, a rolling-element bearing, a jewel bearing, a fluid bearing, a magnetic bearing, a flexure bearing, and any combination thereof. Element 12: wherein at least one of the one or more blades comprise a blade arm operatively coupled to the rotor, and at least one flap pivotably coupled to the blade arm and pivotable between an open position and a closed position.

Element 13: wherein two or more blades of the one or more blades reside in a common horizontal plane. Element 14: further comprising supporting the rotor within the vertical column with one or more support members coupled to the vertical column. Element 15: wherein each support member defines a central aperture through which the rotor passes, the method further comprising providing at least one of radial and axial support to the rotor with a bearing arranged within the central aperture. Element 16: further comprising reducing friction between the rotor and the one or more support members with the bearing. Element 17: wherein the one or more support members comprise a plurality of support members axially offset from each other within the vertical column, and wherein generating electricity as the rotor rotates within the plurality of segmented, vertically aligned magnetic fields comprises rotating the rotor within a plurality of vertically aligned chambers defined within the vertical column by the plurality of support members, wherein the plurality of segmented, vertically aligned magnetic fields are provided within the plurality of vertically aligned chambers. Element 18: wherein the wind turbine further includes one or more generators arranged within the vertical column and each generator includes one or more coils, the method further comprising producing the plurality of segmented, vertically aligned magnetic fields with the one or more coils.

By way of non-limiting example, exemplary combinations applicable to A and B include: Element 1 with Element 2; Element 3 with Element 4; Element 6 with Element 7; Element 8 with Element 9; Element 8 with Element 10; Element 10 with Element 11; Element 14 with Element 15; and Element 15 with Element 16.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure.

What is claimed is:

1. A wind turbine, comprising:
vertical column;
a rotor supported within the vertical column and extending out of the vertical column;
one or more blades coupled to the rotor and extending outward therefrom; and
a plurality of segmented, vertically aligned magnetic fields provided within the vertical column and through which the rotor extends, wherein rotating the rotor within the plurality of segmented, vertically aligned magnetic fields generates electricity.

2. The wind turbine of claim 1, wherein the one or more blades extend horizontally from the rotor.

3. The wind turbine of claim 2, wherein two or more blades of the one or more blades reside in a common horizontal plane.

4. The wind turbine of claim 1, further comprising one or more generators arranged within the vertical column, wherein each generator includes one or more coils and the one or more coils produce the plurality of segmented, vertically aligned magnetic fields.

5. The wind turbine of claim 4, wherein the one or more generators comprise a plurality of generators that are segmented, and vertically aligned within the vertical column.

6. The wind turbine of claim 1, further comprising a magnetic material coupled to the rotor to align with the plurality of segmented, vertically aligned magnetic fields.

7. The wind turbine of claim 1, further comprising a gearbox that receives the rotor, wherein a distal end of the rotor extends from the gearbox and through the plurality of segmented, vertically aligned magnetic fields.

8. The wind turbine of claim 7, wherein the gearbox is housed within the vertical column.

9. The wind turbine of claim 1, further comprising one or more support members coupled to the vertical column, wherein each support member defines a central aperture through which the rotor passes.

10. The wind turbine of claim 9, wherein the one or more support members comprise a plurality of support members axially offset from each other within the vertical column, the wind turbine further comprising:
a plurality of vertically aligned chambers defined within the vertical column by the plurality of support members, wherein the plurality of segmented, vertically aligned magnetic fields are provided within the plurality of vertically aligned chambers.

11. The wind turbine of claim 9, further comprising a bearing arranged in the central aperture of at least one of the one or more support members and interposing the rotor and the at least one of the one or more support members.

12. The wind turbine of claim 11, wherein the bearing comprises a machine element selected from the group consisting of a plain bearing, a rolling-element bearing, a jewel bearing, a fluid bearing, a magnetic bearing, a flexure bearing, and any combination thereof.

13. The wind turbine of claim 1, wherein at least one of the one or more blades comprise:
a blade arm operatively coupled to the rotor; and
at least one flap pivotably coupled to the blade arm and pivotable between an open position and a closed position.

14. A method of generating electricity, comprising:
capturing wind energy with one or more blades of a wind turbine, the wind turbine including a vertical column and a rotor supported within the vertical column and extending out of the vertical column, wherein the one or more blades are coupled to the rotor and extend outward therefrom;
rotating the one or more blades with the wind energy and thereby rotating the rotor; and
generating electricity as the rotor rotates within a plurality of segmented, vertically aligned magnetic fields provided within the vertical column.

15. The method of claim 14, wherein two or more blades of the one or more blades reside in a common horizontal plane.

16. The method of claim 14, further comprising supporting the rotor within the vertical column with one or more support members coupled to the vertical column.

17. The method of claim 16, wherein each support member defines a central aperture through which the rotor passes, the method further comprising providing at least one of radial and axial support to the rotor with a bearing arranged within the central aperture.

18. The method of claim 17, further comprising reducing friction between the rotor and the one or more support members with the bearing.

19. The method of claim 14, wherein the one or more support members comprise a plurality of support members axially offset from each other within the vertical column, and wherein generating electricity as the rotor rotates within the plurality of segmented, vertically aligned magnetic fields comprises:
rotating the rotor within a plurality of vertically aligned chambers defined within the vertical column by the plurality of support members, wherein the plurality of segmented, vertically aligned magnetic fields are provided within the plurality of vertically aligned chambers.

20. The method of claim 14, wherein the wind turbine further includes one or more generators arranged within the vertical column and each generator includes one or more coils, the method further comprising producing the plurality of segmented, vertically aligned magnetic fields with the one or more coils.
